(19) United States
(12) Patent Application Publication
(10) Pub. No.: US 2019/0068999 A1
(43) Pub. Date: Feb. 28, 2019

(54) SYSTEMS AND METHODS FOR AUTHENTICATION OF DIGITAL CONTENT

(71) Applicant: Rovi Guides, Inc., San Jose, CA (US)

(72) Inventors: Carmen Laura Basile, London (GB); Noah Schottenfeld, Sebastopol, CA (US)

(21) Appl. No.: 16/170,872

(22) Filed: Oct. 25, 2018

Related U.S. Application Data
(63) Continuation of application No. 13/439,103, filed on Apr. 4, 2012.
(60) Provisional application No. 61/584,506, filed on Jan. 9, 2012.

(51) Int. Cl. H04N 21/235; H04N 21/4405; H04N 21/4627; H04N 5/913; H04N 21/442; H04N 21/835

(52) U.S. Cl. CPC H04N 21/2351; H04N 21/4405; H04N 21/4627; H04N 5/913; H04N 2005/91342; H04N 21/44236; H04N 21/835; H04N 2005/91392; H04N 21/44204

(57) ABSTRACT

Systems and methods for authenticating a digital file are provided. The systems and methods may operate independently or supplement existing copy protection systems, such as CSS, and help make them more robust. The digital file may be stored on a computer readable medium such as a physical disc, digital content downloaded from the Internet, or any other suitable digital content. In some aspects, the systems and methods described herein include identifying media content stored in a digital file that needs to be authenticated, and subsequently reading suitably chosen media blocks in encrypted (and unencrypted) form from the digital file for comparison with corresponding blocks (e.g., stored in a database) obtained from a genuine copy. The digital file will be authenticated only in the case of a successful match.

### CROSS-REFERENCE TO RELATED APPLICATIONS

This application claims priority to and the benefit of U.S. Provisional Patent Application Ser. No. 61/584,506, filed Jan. 9, 2012, the entire contents of which are incorporated herein by reference.

### BACKGROUND

Copy protection is being increasingly pursued by content providers to help prevent the loss of billions of dollars each year due to casual and professional media piracy. Copy protection is typically found on computer readable media, e.g., digital video discs, computer software discs, video game discs, and audio compact discs. Various systems exist and continue to be proposed to afford copy protection to such media, e.g., the Content Scrambling System (CSS). CSS is a copy protection system originally developed for protecting against illegal copying of Digital Video Discs (DVDs). However, it can be easily cracked by software because CSS uses only 40-bit keys.

### SUMMARY

In view of the foregoing, systems and methods for authenticating a digital file are described herein. The systems and methods may operate independently or supplement existing copy protection systems, such as CSS, and help make them more robust. The digital file may be stored on a computer readable medium such as a physical disc, digital content downloaded from the Internet, or any other suitable digital content.

Content authentication approaches may be divided into two types: content agnostic and content specific. The content agnostic approach exploits generic and inherent differences that typically occur between any genuine copy (e.g., authentic, legally obtained, and/or not counterfeit) and its counterfeit copy (e.g., forged, unauthorized imitation, and/or not genuine), such as media type (read-only or recordable) and region restrictions. For example, a genuine copy will typically be fabricated as read-only media, while a counterfeit copy is typically created using off-the-shelf recordable media. In another example, a genuine copy will typically have a region code (designed to allow distributors to control aspects of a release, including content, release date, and price, according to the region), while a counterfeit copy may have an incorrect or no region code. However, this approach is liable to attacks by filter devices, such as ANYDVD and DVDFAB PASSKEY, that can e.g., make a recordable, non-region restricted disc appear as a read-only, region restricted disc.

The content specific approach is less vulnerable to filter device attacks as it is based on information that is not typically propagated into a counterfeit copy and that cannot be easily fabricated without access to the genuine copy. Depending on the techniques used to produce the counterfeit copy, some information in the copied data (e.g., file system information) may change. In these cases, a hash of the file system information or a hash of the entire contents would suffice in detecting differences between the genuine copy and the counterfeit copy. However, if a byte-by-byte copy technique is used by counterfeiters, the above-proposed approach would fail to identify a counterfeit copy. The systems and methods described hereafter are expected to work even in the case of identical byte-by-byte copies.

In some aspects, the systems and methods described herein include identifying media content stored in a digital file that needs to be authenticated, and subsequently reading suitably chosen media blocks in encrypted (and unencrypted) form from the digital file for comparison with corresponding blocks (e.g., stored in a database) obtained from a genuine copy. The digital file will be authenticated only in the case of a successful match. For example, in the case of a digital file stored in DVD format, suitably chosen sectors (portions of the DVD each having audio-visual data arranged into audio and/or video packs) may be read in scrambled (and unscrambled) form and compared to corresponding data obtained from a genuine disc. In some embodiments, an audio pack or a video pack includes DVD audio or video data spanning one sector. Typically data in scrambled (and unscrambled) form is encrypted (or unencrypted) according to the CSS system. On a typical DVD protected by CSS encryption, a portion of the video packs are CSS-scrambled using a CSS key. However, on a counterfeit copy of a genuine (CSS-protected) DVD the sectors that were CSS-scrambled on the genuine DVD will be typically stored in unscrambled form. This may be the case for recordable media. Even if CSS protection were applied to the counterfeit copy, it is unlikely that exactly the same sectors as in the genuine DVD would be chosen for CSS-scrambling and, furthermore, that the same CSS keys would be used.

In some aspects, the systems and methods described herein include identifying media content stored in a digital file that needs to be authenticated, and subsequently reading the encryption status of suitably chosen media blocks in encrypted (and unencrypted) form from the digital file for comparison with the encryption status of corresponding blocks (e.g., stored in a database) obtained from a genuine copy. The digital file will be authenticated only in the case of a successful match. For example, in the case of a digital file stored in DVD format, encryption status for suitably chosen sectors may be read and compared to corresponding data obtained from a genuine disc. The encryption status (i.e., CSS-scramble status) of a sector is stored in its CPR_MAI header. CPR_MAI headers include copyright management information and are stored within each sector in the DVD. Typically when copying data from a sector the corresponding CPR_MAI header is not copied. A counterfeit copy will usually have no CSS encryption applied (that may be the case for recordable media). Even if CSS were applied on the counterfeit copy (e.g., in the case of professional piracy), it is unlikely that exactly the same sectors would be CSS encrypted. A genuine DVD will have CSS encryption applied to it. Typically only a portion of the video packs will be CSS-encrypted, and which sectors are CSS-encrypted may depend on the authoring tool and the settings used upon authoring.

In some embodiments, digital rights may be associated with a digital file. The digital rights may be unlocked to the possessor of the genuine copy of the digital file. For example, the possessor of a genuine DVD movie may receive digital rights for an online version of the same movie or additional content. However, if authentication for the digital file fails, the possessor of the counterfeit copy will be prevented from receiving any digital rights for additional content. In some embodiments, authentication failure can prevent access to media content on the counterfeit copy itself. The approaches described in this disclosure are applicable to digital files stored on computer readable media such as physical discs, digital content downloaded from the Internet, or any other suitable digital content. For the purposes of this disclosure, it may be assumed that the content in the digital file that needs to be authenticated has been identified correctly and that information extracted from the digital file can be compared against information that was obtained from a genuine copy for that content and that was stored in a database.

In some aspects, the systems and methods described herein include a method for authenticating a digital file using processing circuitry. The method includes receiving an identification of media content included in the digital file, and retrieving data associated with a (non-encrypted or encrypted) reference block based on the identified media content. The method further includes identifying a media block stored in the digital file corresponding to the reference block, and comparing the data associated with the reference block to corresponding data associated with the reference block. The method further includes determining that the digital file is genuine when the comparison is successful.

In some embodiments, the reference block is stored in a genuine copy of the digital file. In some embodiments, the digital file being authenticated and the genuine copy of the digital file are in the same format. In some embodiments, the identification of media content may be received via user input, from processing circuitry that identifies the media content, or any other suitable input. In some embodiments, media content included in the digital file is identified based on a hash value or a volume identifier for the media content. In some embodiments, the data associated with the reference block is retrieved from a remote database. In some embodiments, comparing the data associated with the media block and the data associated with the reference block includes comparing content of the media block to content of the corresponding reference block. In some embodiments, comparing the data associated with the media block and the data associated with the reference block includes comparing the encryption status of the media block and the encryption status of the corresponding reference block. In some embodiments, at least a portion of the reference and media blocks are encrypted using at least one of Content Scramble System (CSS), Advanced Access Content System (AACS), FAIRPLAY, and Protected Media Path (PMP). In some embodiments, the method further includes determining that the digital file is counterfeit when the comparison of the data associated with the reference block to the corresponding data associated with the media block is not successful.

In some embodiments, the digital file is in the form of at least one of the formats selected from the group comprising a Digital Versatile Disc (DVD), Compact Disc (CD), a Blu-ray Disc (BD), a High Density DVD (HD DVD), a Hard Disk Drive (HDD), a Flash Drive, and digital content downloaded from the Internet. In some embodiments, a first portion of the digital file is in the form of a format different from a second portion of the digital file. In some embodiments, each media block stored in the digital file includes an audio portion and/or a video portion.

In some embodiments, determining that the digital file is genuine includes determining whether the digital file is one of a rental version, a retail version, and a subscription version. The method may further include allowing a user to access digital content via the Internet based on whether the digital file is a rental version, a retail version, or a subscription version.

In some aspects, the systems and methods described herein include a system for authenticating a digital file that includes processing circuitry configured to execute the functionality described above.

### BRIEF DESCRIPTION OF THE DRAWINGS

The above and other objects and advantages of the systems and methods described herein will be apparent upon consideration of the following detailed description, taken in conjunction with the accompanying drawings, in which like reference characters refer to like parts throughout, and in which:

FIGS. 1 and 2 show illustrative embodiments of media on-demand display screens that enables access to different types of content in a single display;

FIG. 3 shows an illustrative embodiment of a user equipment device;

FIG. 4 is a diagram of an illustrative embodiment of a cross-platform interactive media system;

FIG. 5 shows an illustrative embodiment of a display screen for providing digital content to a user;

FIG. 6 shows an illustrative embodiment of a block diagram for providing digital content to a user;

FIG. 7 shows an illustrative embodiment of a flow diagram for providing digital content to a user;

FIGS. 8A and 8B show illustrative embodiments of a digital file stored on a computer readable medium;

FIGS. 9A and 9B show illustrative embodiments of media blocks and reference blocks for authenticating a digital file;

FIG. 10 shows an illustrative embodiment of a flow diagram for authenticating a digital file;

FIG. 11 shows an illustrative embodiment of a flow diagram for comparing media blocks and reference blocks;

FIG. 12 shows an illustrative embodiment of another flow diagram for comparing media blocks and reference blocks;

FIG. 13 shows an illustrative embodiment of yet another flow diagram for comparing media blocks and reference blocks;

FIG. 14 shows an illustrative embodiment of a flow diagram for authenticating a digital file stored on a DVD;

FIG. 15 shows another illustrative embodiment of a flow diagram for authenticating a digital file stored on a DVD;

FIG. 16 shows yet another illustrative embodiment of a flow diagram for authenticating a digital file stored on a DVD; and

FIG. 17 shows still another illustrative embodiment of a flow diagram for authenticating a digital file stored on a DVD.

### DETAILED DESCRIPTION OF EMBODIMENTS

The systems and methods described herein provide for authenticating a digital file. The systems and methods may supplement existing copy protection systems, such as CSS, and help make them more robust. The digital file may be stored on a non-transitory computer readable medium such as a physical disc, digital content downloaded from the Internet or any other suitable digital content.

In some aspects, the systems and methods described herein include identifying media stored in a digital file that needs to be authenticated, and reading suitably chosen media blocks in encrypted (and unencrypted) form from the digital file for comparison with corresponding blocks (e.g., stored in a database) obtained from a genuine copy. The digital file will be authenticated only in the case of a successful match. For example, in the case of a digital file stored in DVD format, suitably chosen sectors (portions of the DVD each having audio-visual data arranged into audio and/or video packs) may be read in scrambled (and unscrambled) form and compared to corresponding data obtained from a genuine disc. In some embodiments, an audio pack or a video pack includes DVD audio or video data spanning one sector. Typically data in scrambled (and unscrambled) form is encrypted (or unencrypted) according to the CSS system. On a typical DVD protected by CSS encryption, a portion of the video packs are CSS-scrambled using a CSS key. However, on a counterfeit copy of a genuine (CSS-protected) DVD the sectors that were CSS-scrambled on the genuine DVD will be typically stored in unscrambled form. This may be the case for recordable media. Even if CSS protection were used on the counterfeit copy, it is unlikely that exactly the same sectors as in the genuine DVD would be chosen for CSS-scrambling and, furthermore, that the same CSS keys would be used.

In some aspects, the systems and methods described herein include identifying media stored in a digital file that needs to be authenticated, and reading the encryption status of suitably chosen media blocks in encrypted (and unencrypted) form from the digital file for comparison with the encryption status of corresponding blocks (e.g., stored in a database) obtained from a genuine copy. The digital file will be authenticated only in the case of a successful match. For example, in the case of a digital file stored in DVD format, encryption status for suitably chosen sectors may be read and compared to corresponding data obtained from a genuine disc. The encryption status (i.e., CSS-scramble status) of a sector is stored in its CPR_MAI header. CPR_MAI headers include copyright management information and are stored within each sector in the DVD. Typically when copying data from a sector the corresponding CPR_MAI header is not copied. A counterfeit copy will usually have no CSS encryption applied (that may be the case for recordable media). Even if CSS were applied on the counterfeit copy (e.g., in the case of professional piracy), it is unlikely that exactly the same sectors would be CSS encrypted. A genuine DVD will have CSS encryption applied to it. Typically only a portion of the video packs will be CSS-encrypted, and which sectors are CSS-encrypted may depend on the authoring tool and the settings used upon authoring.

In some embodiments, digital rights are associated with a digital file. The digital rights may be unlocked to the possessor of the genuine copy of the digital file. For example, the possessor of a genuine DVD movie may receive digital rights for an online version of the same movie or additional content. However, if authentication for the digital file fails, the possessor of the counterfeit copy will be prevented from receiving any digital rights for additional content. In some embodiments, authentication failure can prevent access to media content on the counterfeit copy itself. The approaches described in this disclosure are applicable to digital files stored on computer readable media such as physical discs, digital content downloaded from the Internet, or any other suitable digital content. For the purposes of this disclosure, it may be assumed that the content on the digital file that needs to be authenticated has been identified correctly and that information extracted from the digital file can be compared against information that was obtained from a genuine copy for that content and that was stored in a database. In some embodiments, the above described functionality may be implemented in an interactive media guidance application, the details for which are discussed further below.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. Typical types of media guidance applications include interactive television program guides, guides for video-on-demand (VOD) services, guides for personal video recorders (PVRs), and other suitable guidance applications. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a Blu-ray player, a Blu-ray recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media on-demand listings, media-related information (e.g., titles, descriptions, ratings information (e.g., parental control ratings, critic's ratings, etc.), genre or category information, actor information, broadcast times, broadcast channels, logo data for broadcasters' or providers' logos, etc.), media format (e.g., standard definition, high definition, 3D, etc.), advertisement information (e.g., text, images, media clips, etc.), blogs, websites, and any other type of guidance data that is helpful for a user to navigate among and locate desired content selections.

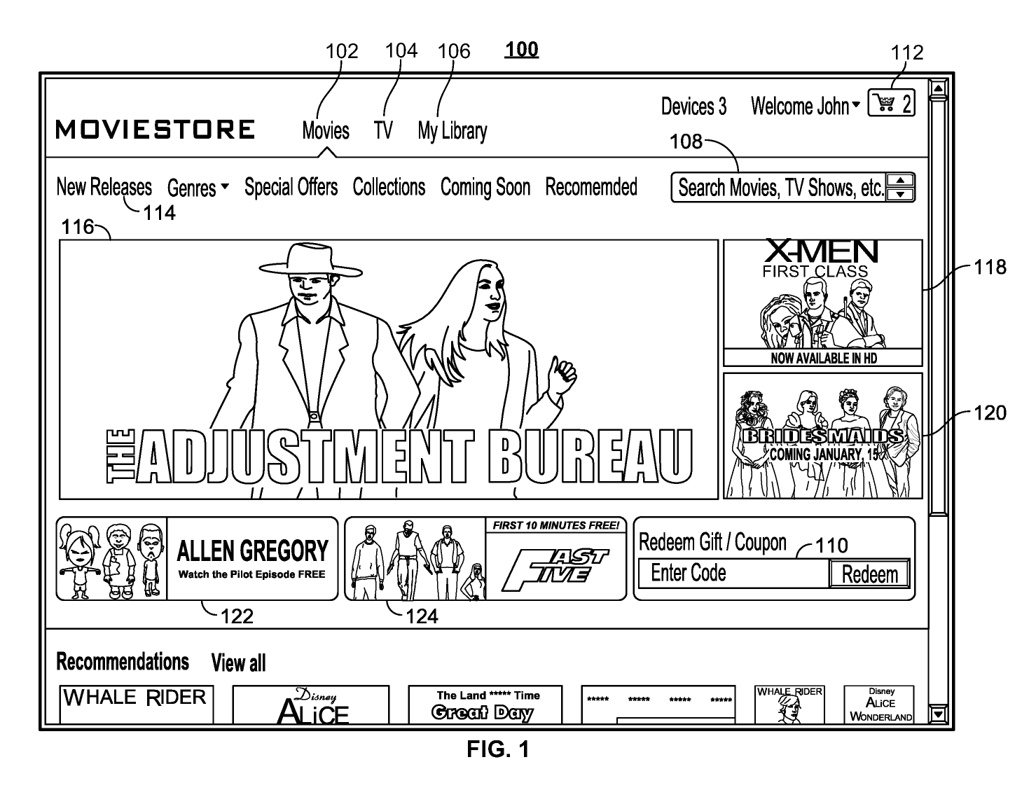

FIGS. 1-2 show illustrative display screens that may be used to provide media guidance data. The display screens shown in FIGS. 1-2 and 5 may be implemented on any suitable user equipment device or platform. While the displays of FIGS. 1-2 and 5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a STORE button) on a remote control or other user input interface or device. In response to the user's indication, the media guidance application may provide a display screen with media guidance data organized in one of several ways, such as by content type, by category (e.g., movies, sports, news, children, or other categories of programming), by time and channel in a grid, by time, by channel, by source, or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative media on-demand display 100 that enables access to different types of content in a single display. Display 100 may include:

(1) Movies tab 102, where users may view featured movie promotions and may browse movie titles organized by one category per row; (2) TV tab 104, where users may browse TV shows by episode and season; and (3) My Library tab 106, where users may view and/or playback any purchased item in their “digital locker” from any compatible device with an Internet connection. With a user input device, a user may select from one of Movies tab 102, TV tab 104, and My Library tab 106, or may search for relevant media via Search box 108. Display 100 may also include “Redeem Gift/Coupon” entry box 110, which allows users to redeem a gift card for store credit or enter a coupon promotion towards the purchase of a specified movie or TV show. In some embodiments, entry box 110 is of type “Code Omnibox.” It may be hard for a customer to understand the difference between, e.g., a gift card code, a gift certificate code, a coupon code, or a digital copy code. The customer may desire the ability to redeem any promotional code from within a single entry box. The “Code Omnibox” entry box allows the user to enter any code, and the media guidance application may automatically determine how to redeem the code and how to enjoy the promotion associated with the code. Display 100 may optionally include shopping cart icon 112. If there are no items in the cart, a message may appear telling the user that the cart is empty or that they need to sign in with their credentials to view items in their cart. If a user has items in their cart added from a particular device and they are viewing the cart from the same device on which the items were added, clicking on the shopping cart may show the items added from that device. In some embodiments, if a user has items in their cart added from any device, clicking on the cart may show their items added from all devices.

Movies tab 102 may further include sub-navigation 114 that enables users to quickly find movies for rent or purchase. For example, sub-navigation 114 may include selectable options for “New Releases,” “Genres,” “Special Offers,” “Collections,” “Coming Soon,” and “Recommended” media content. The “New Releases” option may provide movies released in the past week or another suitable time period. The “Genres” option may allow the user to view movies from a chosen genre such as comedy or another suitable genre. The “Special Offers” option may provide movies with promotions such as free movies, discounted movies, or any other suitable promotion. The “Collections” option may provide movies based on a theme such “70's movies,” “Harrison Ford movies,” or another suitable theme. The “Coming Soon” option may provide trailers and other suitable information for soon-to-be-released movies. Finally, the “Recommended” option may provide the user with suggested movies based on past user interactions, e.g., past movie ratings, past movie selections, or any other suitable past user interaction. Information relating to featured movies and important promotions may be provided in primary region 116 and secondary regions 118 and 120, respectively. Regions 116, 118, and 120 may display static movie titles or multiple rotating movie titles as determined by a content provider. Hovering over a region may cause a mini details dialog to pop up. From the pop up, the user may buy or rent the title or click a link to view the Title Details page described in FIG. 2 below. Although, display 100 is described with respect to Movies tab in the following paragraphs, the description may be equally or appropriately applicable to TV tab 104 and/or My Library tab 106.

In addition to providing access to movie content, the media guidance application may also include regions 122 and 124 for providing access to additional content from different content sources including on-demand content (e.g., VOD), Internet content (e.g., streaming media, downloadable media, etc.), locally stored content (e.g., content stored on any user equipment device described above or other storage device), or other time-independent content. On-demand content may include content provided by a particular content provider (e.g., FOX providing a free pilot episode of “Allen Gregory” or a 10 minute preview of Universal Pictures' “Fast Five”). Internet content may include web events, such as a chat session or Webcast, or content available on-demand as streaming content or downloadable content through an Internet web site or other Internet access (e.g. FTP).

In some embodiments, display 100 may provide media guidance data for on-demand content, recorded content, and Internet content. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast content, only on-demand and broadcast content, etc.).

In some embodiments, region 116 of display 100 may allow the user to view and/or preview movie titles being promoted. Displays including a video region are sometimes referred to as picture-in-guide (PIG) displays.

PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

In some embodiments, regions 118 and 120 in display 100 may provide advertisements for content that, depending on a viewer's access rights (e.g., for subscription programming), is currently available for viewing, will be available for viewing in the future, or may never become available for viewing, and may correspond to or be unrelated to region 116. The advertisements may also be for products or services related or unrelated to the content displayed in region 116. The advertisements may be selectable and provide further information about content, provide information about a product or a service, enable purchasing of content, a product, or a service, provide content relating to the advertisement, etc. Advertisements in regions 118 and 120 may be targeted based on a user's profile/preferences, monitored user activity, the type of display provided, or on other suitable targeted advertisement bases.

While regions 118 and 120 are shown as rectangular or banner shaped, advertisements may be provided in any suitable size, shape, and location in a guidance application display. For example, the advertisement may be provided as a rectangular shape, sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Additional options displayed in display 100 may include search options, VOD options, parental control options, Internet options, cloud-based options, device synchronization options, second screen device options, options to access various types of media guidance data displays, options to subscribe to a premium service, options to edit a user's profile, options to access a browse overlay, options to view related content that provides background information or context for a selected media content, options to view the related content on a second screen device, options to view additional related content, options to add related content to a queue for later viewing, options to resume playback of the selected media content, options to specify an ordering scheme and/or criteria for the ordering scheme, or other suitable options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by signing in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

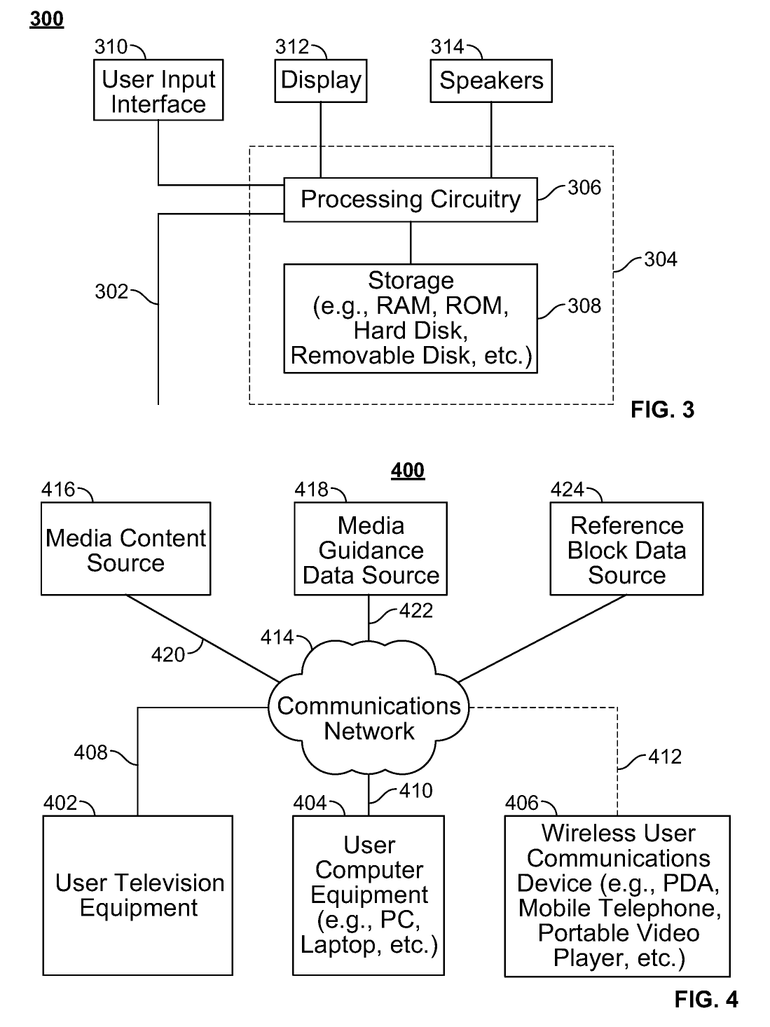

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Display 200 includes selectable options showing all available information from a search for “Alice in Wonderland” in display 100. Though this arrangement is described for a user search, the description below may be equally or appropriately applicable to user selection of a title from display 100. Display 200 may provide media listings including graphical images including cover art, still images from the content, video clip previews, live video from the content, or other types of content that indicate to a user the content being described by the media guidance data relating to “Alice in Wonderland.” Each of the media listings may also be accompanied by text to provide further information about the content. For example, the further information may include cover art 202, access to a trailer 204, and information section 206 including title, rating, duration, release duration, whether available in HD, short description, starring cast, purchase prices, and links to buy or rent. Cover art 202 or access to trailer 204 may be selectable to view content in full-screen or to view information related to the content displayed.

The media listings in display 200 are of different sizes, but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

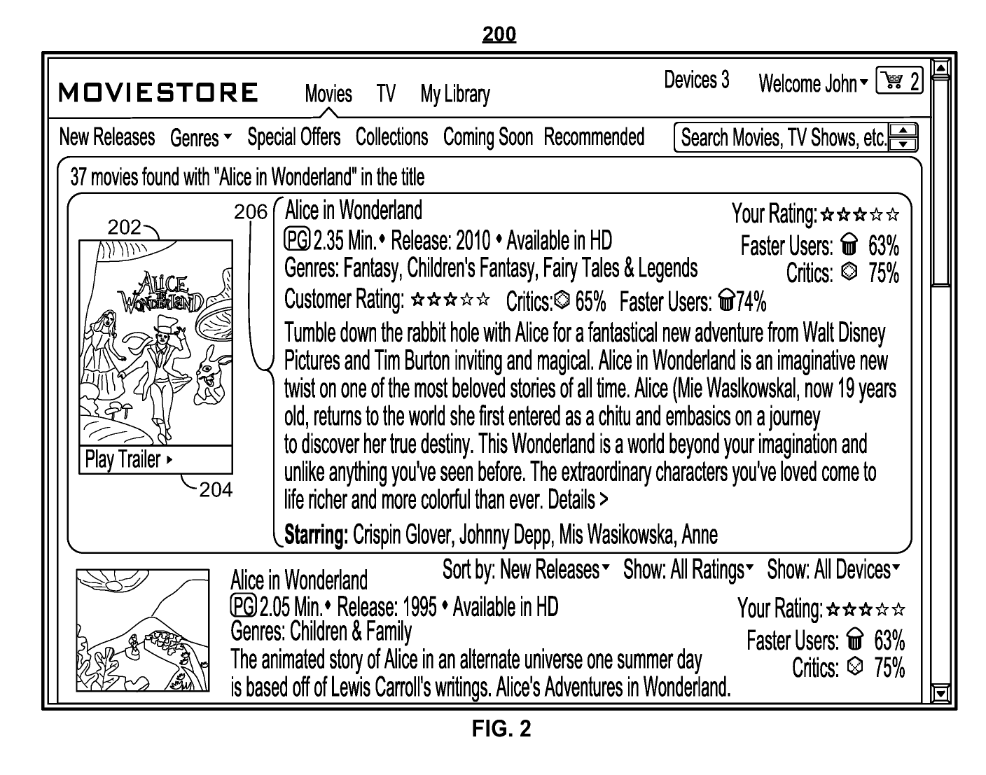

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below.

For example, the media guidance application may provide instructions to control circuitry 304 to generate the media guidance displays. In some implementations, any action performed by control circuitry 304 may be based on instructions received from the media guidance application. In some embodiments, control circuitry 304 executes instructions for identifying media content included in a digital file, retrieve a reference block based on the identified media content, identify a media block stored in the digital file corresponding to the reference block, compare the media block and the reference block, and determine that the digital file is genuine when the media block matches the reference block.

In client-server based embodiments, control circuitry 304 may include communications circuitry suitable for communicating with a guidance application server or other networks or servers. For example, control circuitry 304 may communicate with a remote server that stores reference blocks for different media content. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, Blu-ray disc (BD) recorders, Blu-ray 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308. In some embodiments, memory as described above stores reference blocks that may be used to determine whether a digital file is genuine.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided.

Control circuitry 304 may also include scaler circuitry for upconverting and downconverting content into the preferred output format of the user equipment device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and reference block data source 424, coupled to communications network 414 via communication paths 420 and 422, respectively. Paths 420 and 422 may include any of the communication paths described above in connection with paths 408, 410, and 412. Communications with the content source 416, media guidance data source 418, and the reference block data source 424 may be exchanged over one or more communications paths, but are shown as a single path in FIG. 4 to avoid overcomplicating the drawing. In addition, there may be more than one of each of content source 416, media guidance data source 418, and media reference block data source 424, but only one of each is shown in FIG. 4 to avoid overcomplicating the drawing. (The different types of each of these sources are discussed below.) If desired, one or more of content source 416, media guidance data source 418, and reference block data source 424 may be integrated as one source device. Although communications between sources 416, 418, and 424 with user equipment devices 402, 404, and 406 are shown as through communications network 414, in some embodiments, sources 416, 418, and 424 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Reference block data source 424 may provide reference blocks and related encryption status for a digital file identified based on a hash or a volume identifier for media content stored in the digital file. Reference blocks may be provided to the user equipment devices using any suitable approach. In some embodiments, the guidance application may be a stand-alone interactive television program guide that receives data via a data feed (e.g., a continuous feed or trickle feed). Reference block data may be provided to the user equipment on a television channel sideband, using an in-band digital signal, using an out-of-band digital signal, or by any other suitable data transmission technique. Reference block data may be provided to user equipment on multiple analog or digital television channels.

In some embodiments, reference blocks from reference block data source 424 may be provided to users' equipment using a client-server approach. For example, a user equipment device may pull reference block data from a server, or a server may push reference block data to a user equipment device. In some embodiments, a guidance application client residing on the user's equipment may initiate sessions with source 424 to obtain reference block data when needed, e.g., when the user equipment device receives a request from the user to receive data. Reference block data may be provided to the user equipment with any suitable frequency (e.g., continuously, daily, a user-specified period of time, a system-specified period of time, in response to a request from user equipment, etc.). Reference block data source 424 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance (or reference block) data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance (or reference block) data described above. In addition to content and/or media guidance (or reference block) data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content, guidance, and reference block data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418, and one or more reference block data sources 424. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

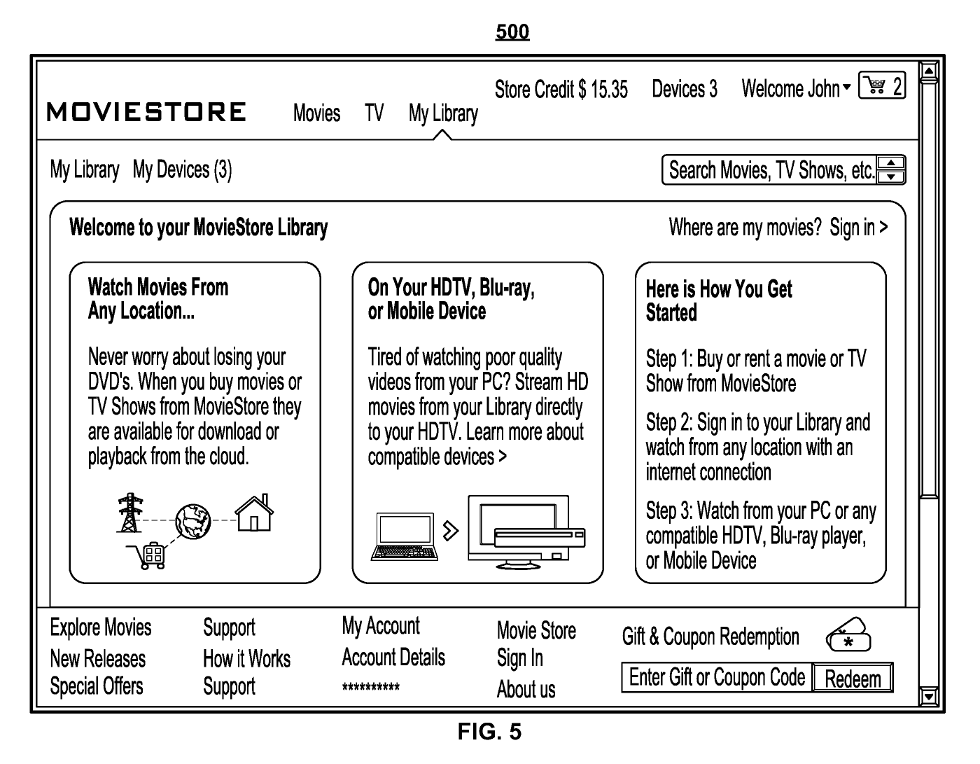

FIG. 5 shows an illustrative display screen 500 for providing digital content to a user. In some embodiments, digital rights may be associated with a digital file. The digital rights may be unlocked to the possessor of the genuine copy of the digital file. For example, the possessor of a genuine DVD movie may receive digital rights for an online version of the same movie or additional content. The user may view the movie or additional content on a mobile device, a television, a personal computer, or any other suitable platform. However, if authentication for the digital file fails, the possessor of the counterfeit copy will be prevented from receiving any digital rights for additional content. Display screen 500 may additionally educate the user on their purchases, e.g., whether the purchased media is in high definition (HD) format, standard definition (SD) format, or another suitable format, and whether the purchased media can be viewed on devices such as HD televisions, Blu-ray players, personal computers, mobile devices, or another suitable device.

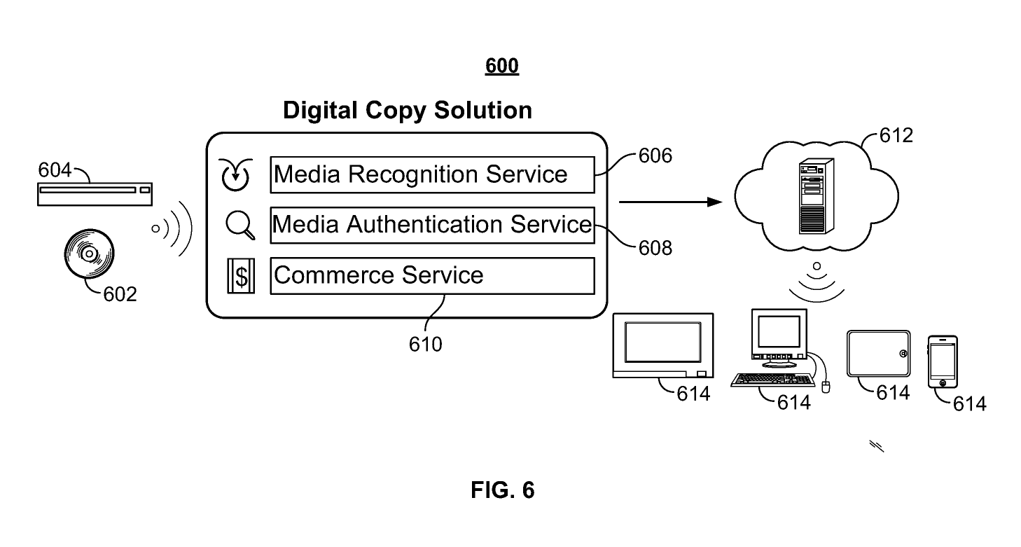

FIG. 6 shows an illustrative block diagram 600 for providing digital content to a possessor of a genuine digital file stored on, e.g., computer readable medium 602. Device 604 (e.g., a consumer electronics device or PC software application) authenticates the digital file, and provides the possessor of the digital file (stored on computer readable medium 602) with a digital copy for download or placed in an online web store or media library. The digital copy may be available from server 612 and provided as an additional purchase or may be included as complimentary bonus content. The possessor may view the digital content on a mobile device, a television, a personal computer, or any other suitable platform 614.

In addition to determining that the digital file stored on computer readable medium 602 is genuine, device 604 can determine whether the digital file is a retail, rental, or subscription version. The digital content (and price) offered to the possessor of the digital file (stored on computer readable medium 602) may be determined based on the version determined by device 604. For example, device 604 may determine that the digital file is a retail version and offer to the possessor a complimentary online version of the media content stored in the digital file. In another example, device 604 may determine that the digital file is a rental version and offer for purchase to the possessor an online version of the media content stored in the digital file or free bonus content such as interviews, trailers, and blooper reels. In yet another example, device 604 may determine that the digital file is a subscription version and display to the possessor titles available through the subscription service that are similar to the media content stored in the digital file. In some embodiments, device 604 includes embedded software that provides media recognition service 606, authentication service 608, and commerce services 610. These services enable the above described functionality and are described further below.

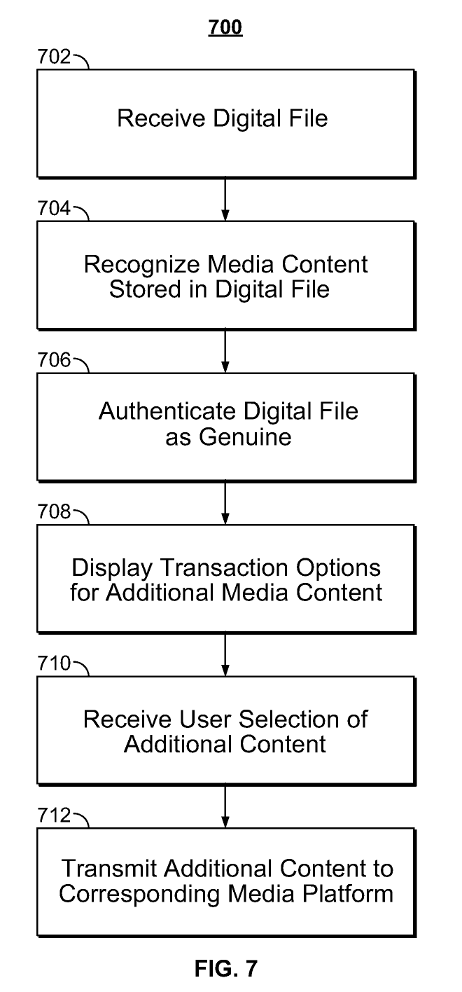

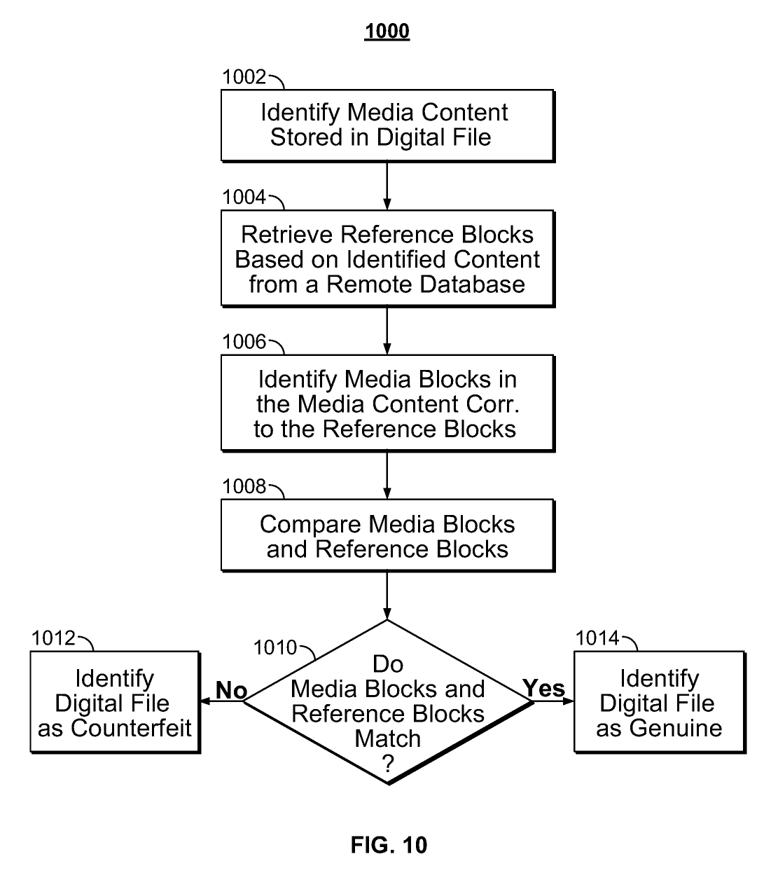

FIG. 7 shows an illustrative flow diagram 700 for providing digital content to a user as described above with reference to FIG. 6. At step 702, device 604 receives a digital file. At step 704, device 604 uses embedded media recognition service 606 to identify the media content stored in the digital file based on, e.g., a volume identifier or a hash related to the digital file. For example, a DVD of Universal Pictures' “Fast Five” may have volume identifier “FAST_FIVE,” which may be used to identify the digital file stored on the DVD format. In another example, device 604 may apply a hash function to the digital file stored in the “Fast Five” DVD and use the resulting hash value to identify the digital file stored on the DVD. A hash function projects a value from a set with many (or even an infinite number of) members to a hash value from a set with a fixed number of (fewer) members. Hash functions can be used to determine if two objects are equal. At step 706, device 604 uses embedded authentication service 608 to determine whether the digital file is genuine. Authentication service 608 may use one or more of the approaches described with respect to FIGS. 10-13 below to authenticate the digital file. At step 708, device 604 allows the user to purchase and/or download additional media content, e.g., complimentary bonus content or an online version of the media content stored in the digital file. At step 710, device 604 receives user selection of desired additional content and provides a download option or places the content in an online web store or media library. At step 712, the user can transmit a request to view the digital content from a mobile device, a television, a personal computer, or any other suitable platform.

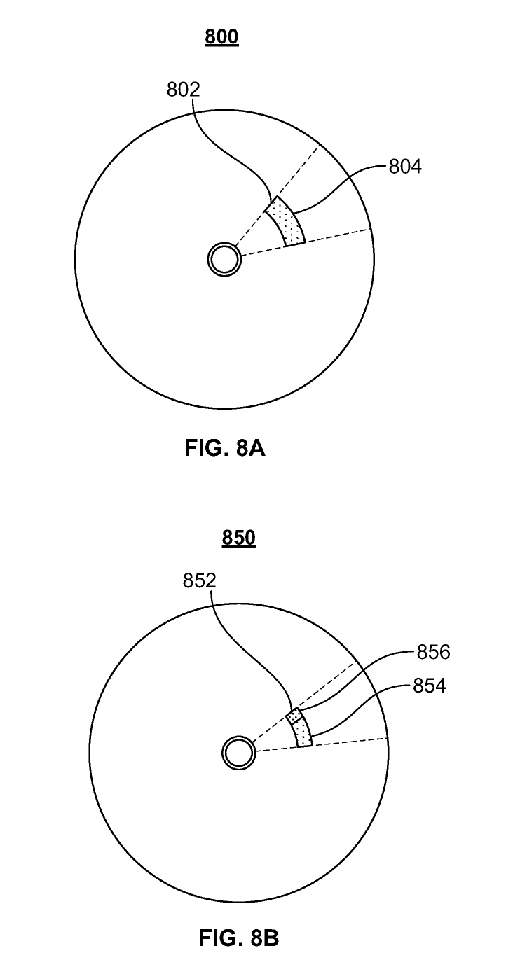

FIGS. 8A and 8B show illustrative embodiments of a digital file stored on a computer readable medium. In particular, FIGS. 8A and 8B illustrate portions that can be read to determine whether the digital file stored on the computer readable medium is genuine or counterfeit. In FIG. 8A, a DVD 800 is shown having media block 804 stored at address 802. Media block 804 can be a sector having audio and/or video information that is encrypted using CSS. Similarly, FIG. 8B shows a DVD 850 having media block 854 stored at address 852. Media block 854 can be a sector having audio and/or video information that is encrypted using CSS. In addition, media block 854 includes CSS-scramble status identifier 856 that indicates whether media block 854 is encrypted or un-encrypted. Alternatively, CSS-scramble status identifiers may be stored in a particular location on the DVD instead of being stored within each media block. Multiple media blocks (and CSS-scramble status) on the DVD may be read to determine whether the digital file stored on the DVD is genuine or counterfeit.

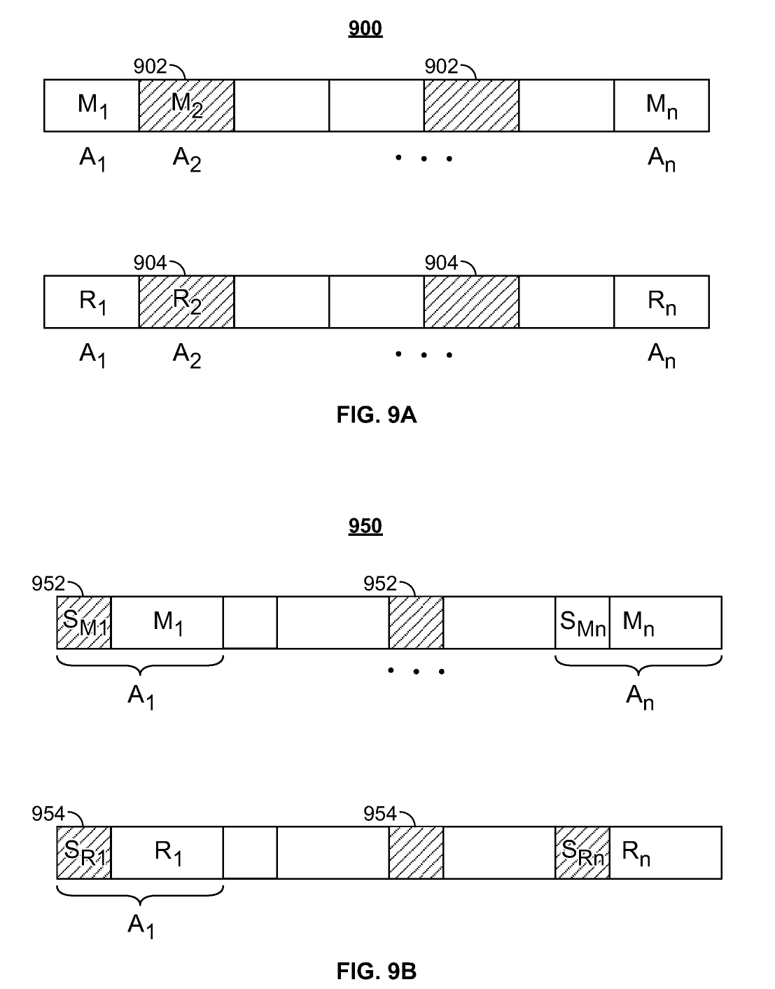

FIG. 9A shows illustrative media blocks 902 and reference blocks 904 for authenticating a digital file 900. Media blocks 902 are suitably chosen (e.g., on predetermined or random basis) from the digital file that needs to be authenticated. Reference blocks 904 (e.g., stored in a database) are retrieved for comparison from a genuine copy. The comparison may include calculating hash values for one or more files stored on media blocks 902, and comparing the hash values with corresponding hash values for reference blocks 904. Media blocks 902 and corresponding reference blocks 904 are typically stored at the same address. The digital file will be authenticated only in the case of a successful match between media blocks 902 and reference blocks 904. For example, in the case of a DVD, predetermined or randomly chosen sectors may be read and compared to corresponding data obtained from a genuine disc. On a typical DVD protected by CSS encryption, a portion of the video packs are CSS-scrambled using a CSS key. However, on a counterfeit copy of a genuine (CSS-protected) DVD the sectors that were CSS-scrambled on the genuine DVD will be typically stored in unscrambled form.

FIG. 9B shows illustrative media blocks 952 and reference blocks 954 for authenticating a digital file 950. Media blocks (including encryption status 952 that indicates whether the media block is encrypted or unencrypted) are suitably chosen (e.g., on predetermined or random basis) from the digital file that needs to be authenticated. Reference blocks (including encryption status 954) from a genuine copy are retrieved from a database for comparison. In some embodiments, only encryption status 954 for the reference blocks are retrieved from the database. The comparison includes comparing encryption status of the respective blocks. The digital file will be authenticated only in the case of a successful match between encryption status 952 for the media blocks and encryption status 954 for the reference blocks.

For example, in the case of digital file stored in a DVD format, encryption status for predetermined or randomly chosen sectors may be read and compared to corresponding data obtained from a genuine digital file stored on such a disc. The encryption status (i.e., CSS-scramble status) of a sector is stored in its CPR_MAI header. CPR_MAI headers include copyright management information and are stored within each sector in the DVD. Typically when copying data from a sector the corresponding CPR_MAI header is not copied. A counterfeit copy will usually have no CSS encryption applied (that may be the case for recordable media). Even if CSS were applied on the counterfeit copy (e.g., in the case of professional piracy), it is unlikely that exactly the same sectors would be CSS encrypted. A genuine DVD will have CSS encryption applied to it. Typically only a portion of the video packs will be CSS-encrypted, and which sectors are CSS-encrypted may depend on the authoring tool and the settings used upon authoring. It is noted that a digital file stored on a DVD with CSS encryption is discussed in this disclosure for illustrative purposes only, and the described embodiments may be equally applicable to digital files stored on other types of computer readable media or downloaded from the Internet, including in combination with other types of copy protection systems.

FIG. 10 shows an illustrative flow diagram 1000 for authenticating a digital file implemented on processing circuitry included in, e.g., user equipment device 300 or device 604. At step 1002, processing circuitry 306 identifies media content stored in the received digital file. The media content may be identified based on a hash of the content, or a volume identifier for the digital file. For example, a digital file in DVD format of Universal Pictures' “Fast Five” may have volume identifier “FAST_FIVE,” which may be used to identify the media content stored in the digital file. In another example, device 604 may apply a hash function to the digital file stored in the DVD format and use the resulting hash value to identify the media content. A hash function projects a value from a set with many (or even an infinite number of) members to a hash value from a set with a fixed number of (fewer) members. Hash functions can be used to determine if two objects are equal. At step 1004, processing circuitry 306 communicates with reference block data source 424 and retrieves reference blocks based on the identified content (e.g., corresponding to the volume identifier or calculated hash value). In some embodiments, reference block data source 424 is a remote database connected to user equipment device 300 via, e.g., the Internet. In some embodiments, reference block data source 424 includes reference blocks obtained from a genuine copy of a physical disc. In some embodiments, reference block data source 424 includes reference blocks obtained from a genuine copy of digital content downloaded from the Internet. The reference blocks may be encrypted or unencrypted blocks obtained from a genuine copy and may be suitably chosen, e.g., on a predetermined basis or a random selection. On a counterfeit copy of, e.g., a genuine digital file stored in (CSS-protected) DVD format, the sectors that were CSS-scrambled in the genuine digital file will be typically stored in unscrambled form. Even when CSS protection were used on the counterfeit copy, it is unlikely that exactly the same sectors as in the genuine digital file would be chosen for CSS-scrambling using the same CSS keys. Accordingly, at least one reference block is encrypted for purposes of the authentication process.

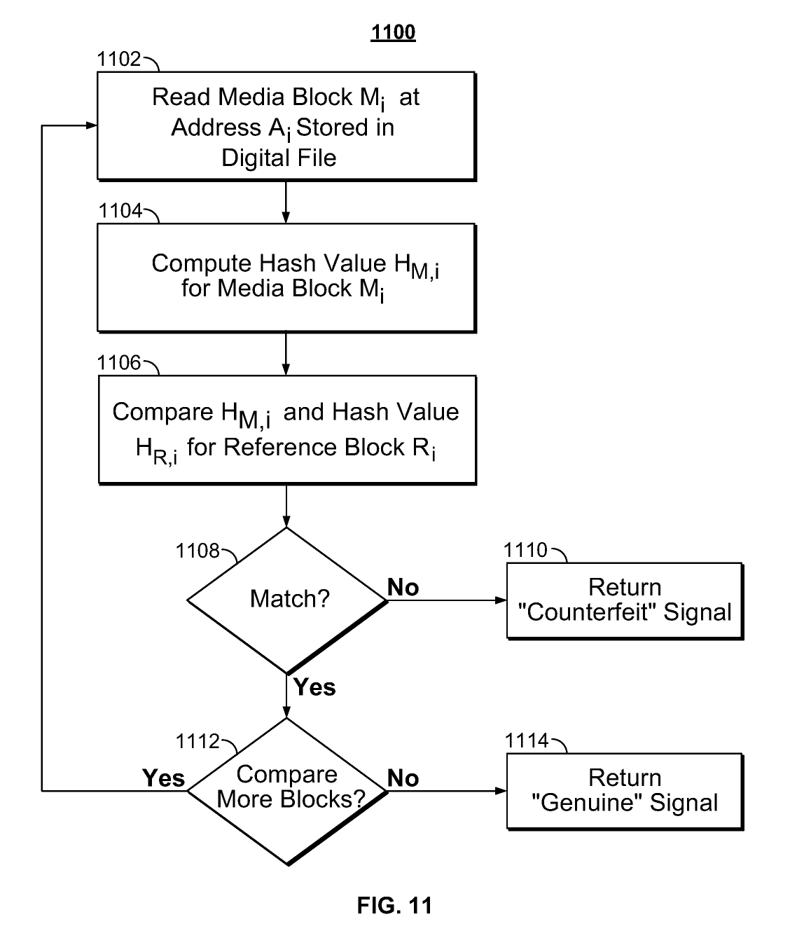

At step 1006, processing circuitry 306 identifies media blocks stored in the digital file corresponding to the reference blocks. At step 1008, processing circuitry 306 compares the media blocks and the reference blocks to determine whether the digital file is genuine. For example, in the case of a digital file stored in a DVD format, predetermined or randomly chosen sectors may be read in scrambled (and unscrambled) form and compared to corresponding data obtained from a genuine digital file stored on such a disc. Any encrypted blocks need not be decrypted for the purposes of the comparison since an encrypted media block and a corresponding encrypted reference block are expected to include similar data. In some embodiments, the media blocks and the reference blocks are compared on a user equipment device (e.g., device 300). In such a case, the user equipment device retrieves the reference blocks for comparison. In some embodiments, the media blocks and the reference blocks are compared on a server (e.g., reference block data source 424). In such a case, the media blocks are sent to the server for comparison. Further embodiments for step 1008 are provided with respect to FIGS. 11-13 below. At step 1010, if processing circuitry 306 determines that the digital file is genuine, processing circuitry 306 identifies the result to the user at step 1014. For example, processing circuitry 306 may display the result on display 312, and optionally provide options for retrieving additional online content. If processing circuitry 306 determines that the digital file is counterfeit, processing circuitry 306 identifies the result to the user at step 1012. For example, processing circuitry 306 may display the result on display 312, and optionally prevent further access to the digital file.

FIG. 11 shows an illustrative flow diagram 1100 for comparing media blocks and reference blocks (corresponding to step 1008 of FIG. 10). This embodiment compares a hash value of each media block with a hash value of a corresponding reference block stored in the digital file. Based on the selected reference blocks, the following information may be retrieved from reference block data source 424 in the form of addresses A (where blocks are stored in the digital file), hash values H (that are calculated for blocks stored at addresses A), and encryption status flags S (that indicate whether the blocks stored at addresses A are encrypted or unencrypted):

(A₁, H_{R, 1}, S_{R, 1}) for encrypted block K(R₁),

(A₂, H_{R, 2}, S_{R, 2}) for encrypted block K(R₂),

(Aₙ, H_{R, n}, S_{R, n}) for encrypted block K(Rₙ),

(Aₙ₊₁, H_{R, n+1}, S_{R, n+1}) for unencrypted block Rₙ₊₁,

(Aₙ₊₂, H_{R, n+2}, S_{R, n+2}) for unencrypted block Rₙ₊₂,

(Aₙ₊ₘ, H_{R, n+m}, S_{R, n+m}) for unencrypted block Rₙ₊ₘ,

where, n is a number of encrypted blocks,

m is the number of unencrypted blocks,

H_{R, i}=H(K(Rᵢ)) is the hash function for 1≤i≤n+m, and

K(Rᵢ) is block Rᵢ encrypted with key K for 1≤i≤n+m,

It is noted that knowledge of key K is not required for the purposes of the systems and methods described herein. Since the hash value for a media block or a reference block is calculated based on the encrypted data, the blocks need not be decrypted for performing the comparison of the media block and the reference block.

At step 1102, processing circuitry 306 reads the ith media block Mᵢ from address Aᵢ corresponding to reference block Rᵢ at address Aᵢ (where i may be received from processing circuitry 306, a user, a remote database or another suitable source). At step 1104, processing circuitry 306 computes hash value H_{M, i} for (encrypted or unencrypted) media block Mᵢ. At step 1106, processing circuitry 306 compares hash values H_{M, i} for the media block and H_{R, n} for the reference block. At step 1108, processing circuitry 306 determines if the hash values H_{M, i} and H_{R, i} match (i.e., are equal), and returns a counterfeit signal at step 1110 in case of mismatch. If the hash values H_{M, i} and H_{R, i} match, processing circuitry 306 moves to step 1112 and checks whether additional media blocks need to be compared against retrieved reference blocks. For example, a certain number of media blocks may need to be compared to corresponding reference blocks before considering the digital file as genuine. The number of blocks to compare may be predetermined or based on a random selection. If additional reference blocks remain, processing circuitry 306 proceeds to step 1102 and repeats the comparison process, otherwise processing circuitry 306 returns a genuine signal at step 1114.

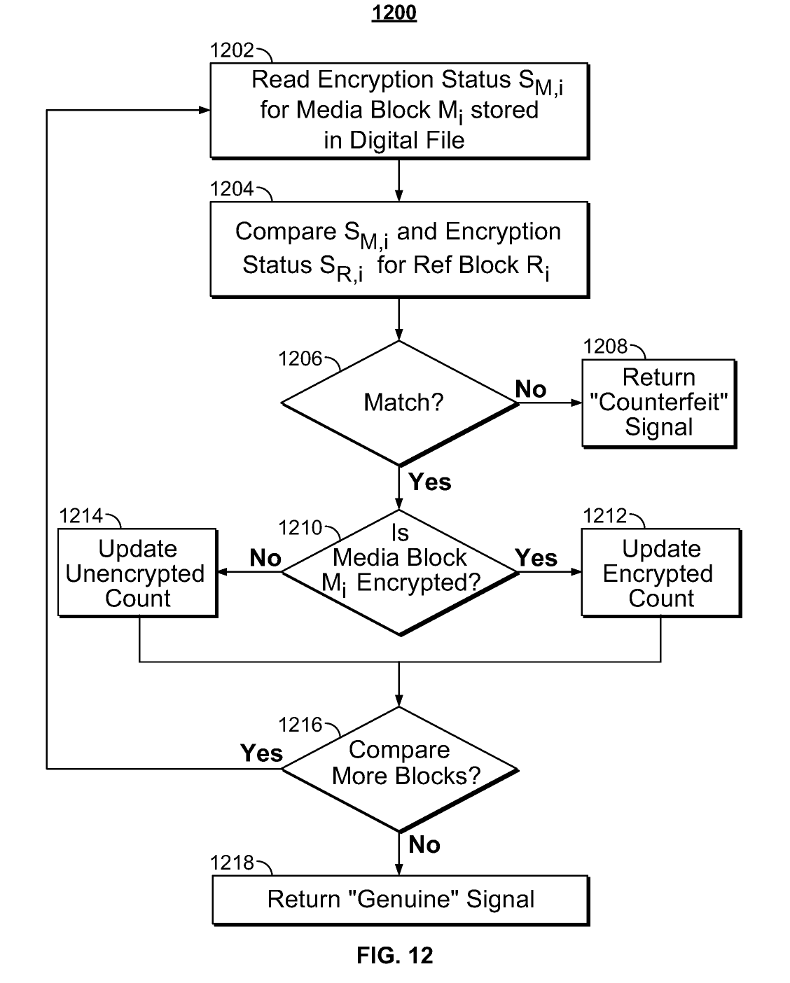

FIG. 12 shows another illustrative flow diagram 1200 for comparing media blocks and reference blocks (corresponding to step 1008 of FIG. 10). This embodiment compares encryption status of the reference blocks with encryption status of corresponding media blocks stored in the digital file. Based on the selected reference blocks, the following information may be retrieved from reference block data source 424 in the form of addresses A (where blocks are stored in the digital file) and encryption status flags S (that indicate whether the blocks stored at addresses A are encrypted or unencrypted):

(A₁, S_{R, 1}) for encrypted block K(R₁),

(A₂, S_{R, 2}) for encrypted block K(R₂),

(Aₙ, S_{R, n}) for encrypted block K (Rₙ),

(Aₙ₊₁, S_{R, n+1}) for unencrypted block Rₙ₊₁,

(Aₙ₊₂, S_{R, n+2}) for unencrypted block Rₙ₊₂,

(Aₙ₊ₘ, S_{R, n+m}) for unencrypted block Rₙ₊ₘ,

where, n is the number of encrypted blocks,

m is the number of unencrypted blocks, and

K(Rᵢ) is block Rᵢ encrypted with key K for 1≤i≤n+m

It is noted that knowledge of key K is not required for the purposes of the systems and methods described herein. Since the hash value for a media block or a reference block is calculated based on the encrypted data, the blocks need not be decrypted for performing the comparison of the media block and the reference block.

At step 1202, processing circuitry 306 reads encryption status S_{M, i} for the ith media block Mᵢ stored at address Aᵢ of the digital file (where i may be received from processing circuitry 306, a user, a remote database or another suitable source). At step 1204, processing circuitry 306 compares encryption status A_{M, i} for the media block and S_{R, i} for the reference block stored at address Aᵢ. At step 1206, processing circuitry 306 determines if the encryption status S_{M, i} and S_{R, i} match (i.e., are equal), and returns a counterfeit signal at step 1208 in case of mismatch. If the encryption status S_{M, i} and S_{R, i} match, processing circuitry 306 moves to step 1210 and checks whether encryption status S_{M, i} for media block Mᵢ is encrypted or unencrypted, and updates counts for encrypted and unencrypted blocks at steps 1212 or 1214 as indicated. At step 1216, processing circuitry 306 determines if additional media blocks need to be compared against retrieved reference blocks. The blocks to compare may be predetermined or based on a random selection, and may include a required number of encrypted and/or unencrypted blocks that need to be compared for a genuine signal to be generated. If additional reference blocks remain, processing circuitry 306 proceeds to step 1202 and repeats the comparison process, otherwise processing circuitry 306 returns a genuine signal at step 1218.

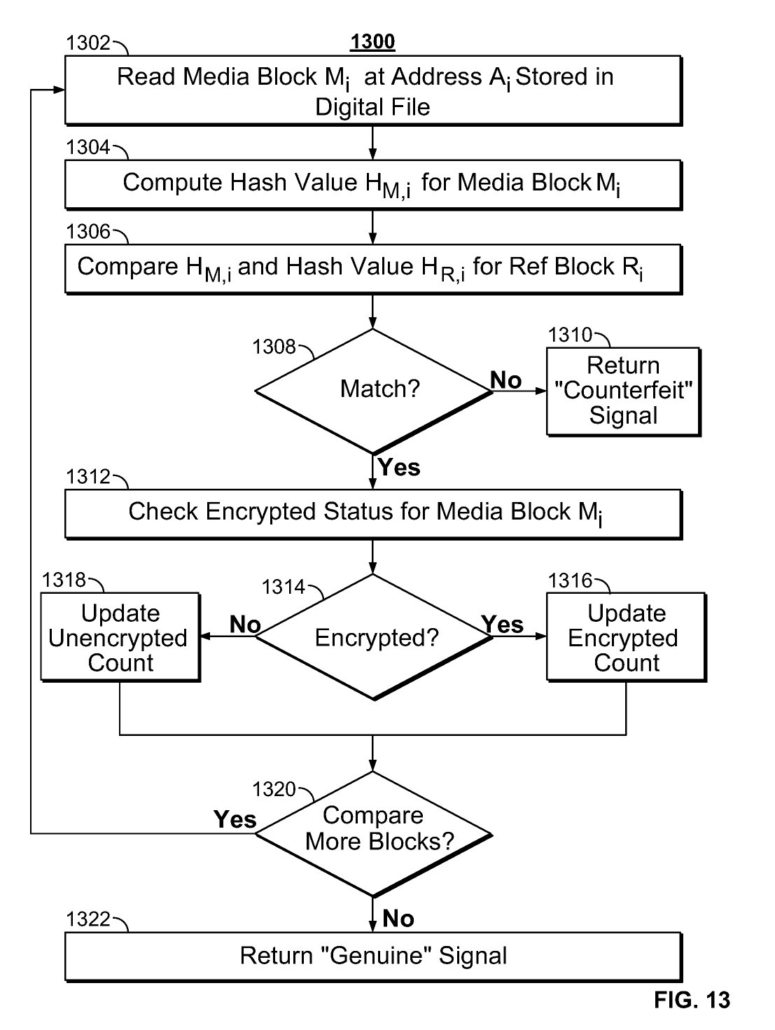

FIG. 13 shows yet another illustrative flow diagram 1300 for comparing media blocks and reference blocks (corresponding to step 1008 of FIG. 10). This embodiment compares a hash value of each media block with a hash value of a corresponding reference block stored in the digital file. Additionally, this embodiment enforces that a required number of encrypted and/or unencrypted blocks be compared for a genuine signal to be generated. Based on the selected reference blocks, the following information may be retrieved from reference block data source 424 in the form of addresses A (where blocks are stored in the digital file), hash values H (that are calculated for blocks stored at addresses A), and encryption status flags S (that indicate whether the blocks stored at addresses A are encrypted or unencrypted):

(A₁, H_{R, 1}, S_{R, 1}) for encrypted block K(R₁),

(A₂, H_{R, 2}, S_{R, 2}) for encrypted block K(R₂),

(Aₙ, H_{R, n}, S_{R, n}) for encrypted block K(Rₙ),

(Aₙ₊₁, H_{R, n+1}, S_{R, n+1}) for unencrypted block Rₙ₊₁,

(Aₙ₊₂, H_{R, n+2}, S_{R, n+2}) for unencrypted block Rₙ₊₂,

(Aₙ₊ₘ, H_{R, n+m}, S_{R, n+m}) for unencrypted block Rₙ₊ₘ,

where, n is the number of encrypted blocks,

m is the number of unencrypted blocks,

H_{R, i}=H(K(Rᵢ)) is the hash function for 1≤i≤n+m, and

K(Rᵢ) is block Rᵢ encrypted with key K for 1≤i≤n+m

It is noted that knowledge of key K is not required for the purposes of the systems and methods described herein. Since the hash value for a media block or a reference block is calculated based on the encrypted data, the blocks need not be decrypted for performing the comparison of the media block and the reference block.

At step 1302, processing circuitry 306 reads the ith media block Mᵢ from address Aᵢ corresponding to reference block Rᵢ at address Aᵢ (where i may be received from processing circuitry 306, a user, a remote database or another suitable source). At step 1304, processing circuitry 306 computes hash value H_{M, i} for (encrypted or unencrypted) media block Mᵢ. At step 1306, processing circuitry 306 compares hash values H_{M, i} for the media block and H_{R, i} for the reference block. At step 1308, processing circuitry 306 determines if the hash values H_{M, i} and H_{R, i} match, and returns a counterfeit signal at step 1310 in case of mismatch. If the hash values H_{M, i} and H_{R, i} match (i.e., are equal), processing circuitry 306 moves to step 1312 and checks whether encryption status S_{M, i} for media block Mᵢ is encrypted or unencrypted. At step 1314, processing circuitry 306 determines whether to update the unencrypted or encrypted block counts. Processing circuitry 306 updates counts for encrypted and unencrypted blocks at steps 1316 or 1318 depending on the outcome of step 1314. At step 1320, processing circuitry 306 determines whether additional media blocks need to be compared against retrieved reference blocks. For example, a certain number of media blocks may need to be compared to corresponding reference blocks before considering the digital file as genuine. The number of blocks to compare may be predetermined or based on a random selection. If additional reference blocks remain, processing circuitry 306 proceeds to step 1302 and repeats the comparison process, otherwise processing circuitry 306 returns a genuine signal at step 1322.

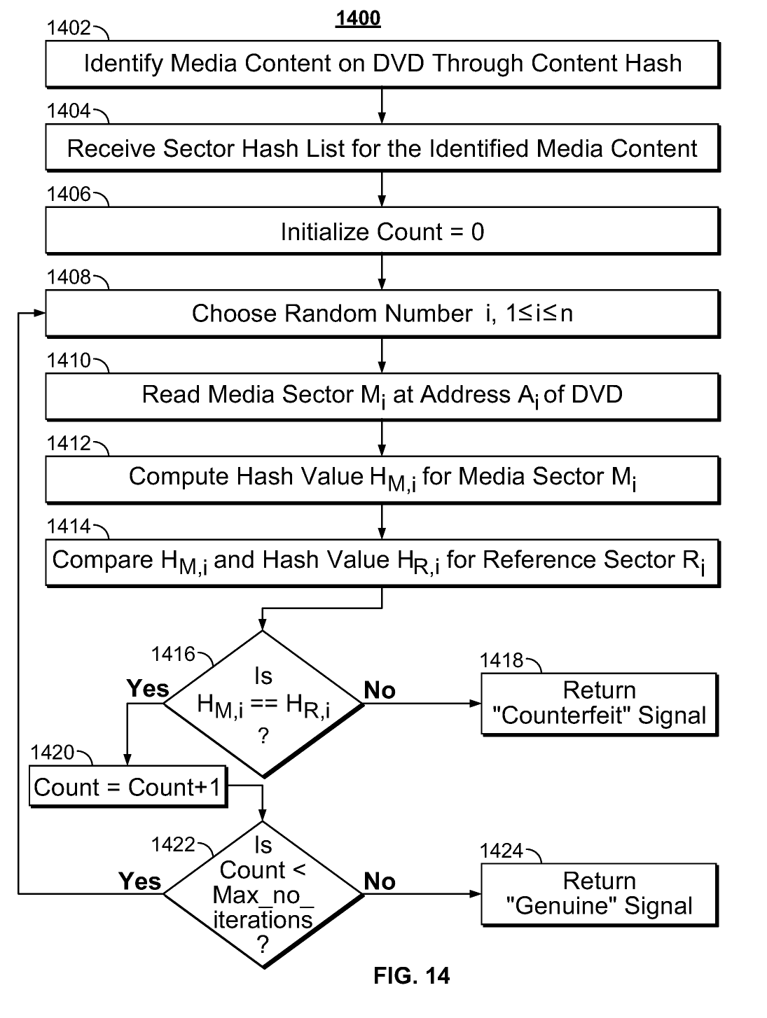

FIG. 14 shows an illustrative embodiment of a flow diagram 1400 for authenticating a digital file stored on a DVD implemented on processing circuitry included in, e.g., user equipment device 300 or device 604. This embodiment compares a hash value of a scrambled reference sector with a hash value of a corresponding scrambled media sector in the digital file stored on the DVD. At step 1402, processing circuitry 306 identifies media content in the received digital file on the DVD. The media content is identified based on a hash of the content. For example, device 604 may apply a hash function to the files stored on a DVD of Universal Pictures' “Fast Five” and use the resulting hash value to identify the movie stored on the DVD. At step 1404, processing circuitry 306 communicates with reference block data source 424 and retrieves a sector hash list for the identified media content. The sector hash list may include the following information in the form of addresses A (where sectors are stored in the digital file on the DVD), hash values H (that are calculated for sectors stored at addresses A), and scramble status flags S (that indicate whether the sectors stored at addresses A are scrambled or unscrambled):

(A₁, H_{R, 1}, S_{R, 1}) for scrambled sector K(R₁),

(A₂, H_{R, 2}, S_{R, 2}) for scrambled sector K(R₂),

(Aₙ, H_{R, n}, S_{R, n}) for scrambled sector K(Rₙ),

where, n is the number of scrambled sectors,

H_{R, i}=H(K(Rᵢ)) is the hash function for 1≤i≤n, and

K(Rᵢ) is sector Rᵢ scrambled with key K for 1≤i≤n

It is noted that knowledge of key K is not required for the purposes of the systems and methods described herein. Since the hash value for a media sector or a reference sector is calculated based on the scrambled data, the sectors need not be unscrambled for performing the comparison of the media sector and the reference sector.

At step 1406, processing circuitry 306 initializes variable count=0. The variable count keeps track of the number of comparison iterations that are performed. Processing circuitry 306 stops the process when variable count reaches value max_no_iterations, which may be provided by the user, received from a remote database, preset in device 300, or through other suitable means. At step 1408, processing circuitry 306 chooses a random number i between 1 and n. At step 1410, processing circuitry 306 reads media sector Mᵢ from address Aᵢ corresponding to reference sector Rᵢ at address Aᵢ. At step 1412, processing circuitry 306 computes hash value H_{M, i} for scrambled media sector Mᵢ. At step 1414, processing circuitry 306 compares hash values H_{M, i} for the media sector and H_{R, n} for the reference sector. At step 1416, processing circuitry 306 determines if the hash values H_{M, i} and H_{R, i} are equal, and returns a counterfeit signal at step 1418 in case of mismatch. If the hash values H_{M, i} and H_{R, i} are equal, processing circuitry 306 increments variable count by 1 at step 1420, and then moves to step 1422 and checks whether variable count has reached max_no_iterations. If additional iterations remain, processing circuitry 306 proceeds to step 1408 and repeats the comparison process, otherwise processing circuitry 306 returns a genuine signal at step 1424.

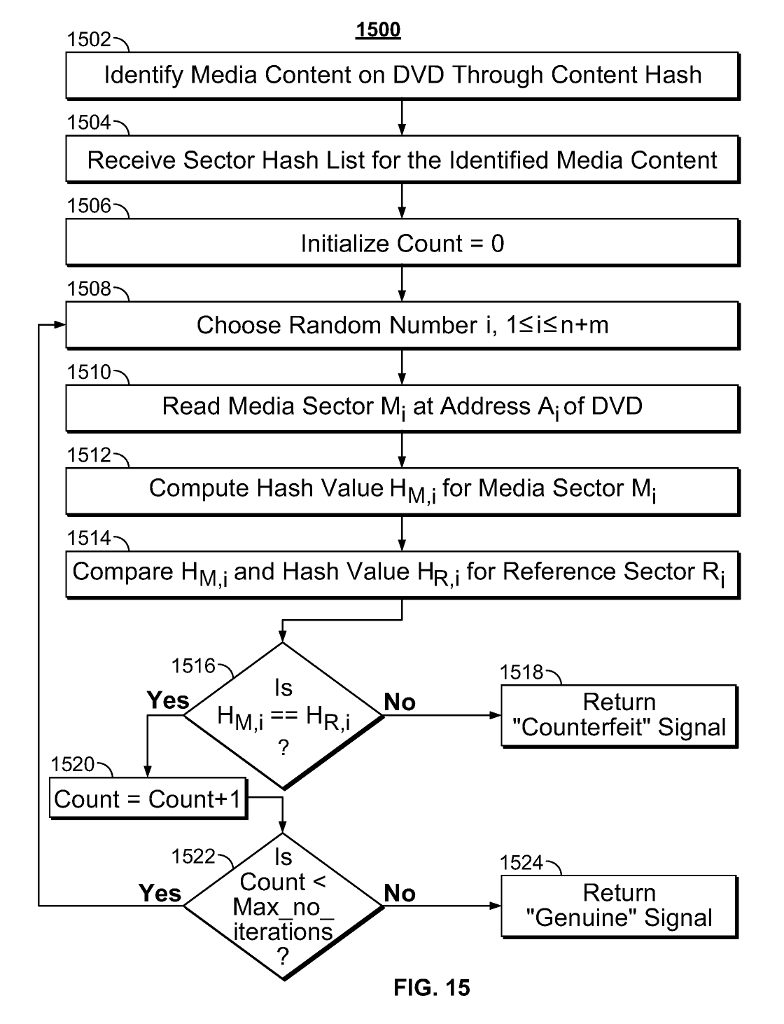

FIG. 15 shows illustrative embodiment of a flow diagram 1500 for authenticating a digital file stored on a DVD implemented on processing circuitry included in, e.g., user equipment device 300 or device 604. This embodiment compares a hash value of a scrambled or an unscrambled reference sector with a hash value of a corresponding media sector in the digital file on the DVD. At step 1502, processing circuitry 306 identifies media content stored on the received DVD. The media content is identified based on a hash of the content. For example, device 604 may apply a hash function to the files stored on a DVD of Universal Pictures' “Fast Five” and use the resulting hash value to identify the movie stored on the DVD. At step 1504, processing circuitry 306 communicates with reference block data source 424 and retrieves a sector hash list for the identified media content. The sector hash list may include the following information in the form of addresses A (where sectors are stored on the DVD), hash values H (that are calculated for sectors stored at addresses A), and scramble status flags S (that indicate whether the sectors stored at addresses A are scrambled or unscrambled):

(A₁, H_{R, 1}, S_{R, 1}) for scrambled sector K(R₁),

(A₂, H_{R, 2}, S_{R, 2}) for scrambled sector K(R₂),

(Aₙ, H_{R, n}, S_{R, n}) for scrambled sector K(Rₙ),

(Aₙ₊₁, H_{R, n+1}, S_{R, n+1}) for unscrambled sector Rₙ₊₁,

(Aₙ₊₂, H_{R, n+2}, S_{R, n+2}) for unscrambled sector Rₙ₊₂,

(Aₙ₊ₘ, H_{R, n+m}, S_{R, n+m}) for unscrambled sector Rₙ₊ₘ,

where, n is the number of scrambled sectors,

m is the number of unscrambled sectors,

H_{R, i}=H(K(Rᵢ)) is the hash function for 1≤i≤n+m, and

K(Rᵢ) is sector Rᵢ scrambled with key K for 1≤i≤n+m

It is noted that knowledge of key K is not required for the purposes of the systems and methods described herein. Since the hash value for a media sector or a reference sector is calculated based on the scrambled data, the sectors need not be decrypted for performing the comparison of the media sector and the reference sector.

At step 1506, processing circuitry 306 initializes variable count=0. The variable count keeps track of the number of comparison iterations that are performed. Processing circuitry 306 stops the process when variable count reaches value max_no_iterations, which may be provided by the user, received from a remote database, preset in device 300, or through other suitable means. At step 1508, processing circuitry 306 chooses a random number i between 1 and n+m. At step 1510, processing circuitry 306 reads media sector Mᵢ corresponding from address Aᵢ to reference sector Rᵢ at address Aᵢ. At step 1512, processing circuitry 306 computes hash value H_{M, i} for scrambled (or unscrambled) media sector Mᵢ. At step 1514, processing circuitry 306 compares hash values H_{M, i} for the media sector and H_{R, n} for the reference sector. At step 1516, processing circuitry 306 determines if the hash values H_{M, i} and H_{R, i} are equal, and returns a counterfeit signal at step 1518 in case of mismatch. If the hash values H_{M, i} and H_{R, i} are equal, processing circuitry 306 increments variable count by 1 at step 1520, and then moves to step 1522 and checks whether variable count has reached max no iterations. If additional iterations remain, processing circuitry 306 proceeds to step 1408 and repeats the comparison process, otherwise processing circuitry 306 returns a genuine signal at step 1524.

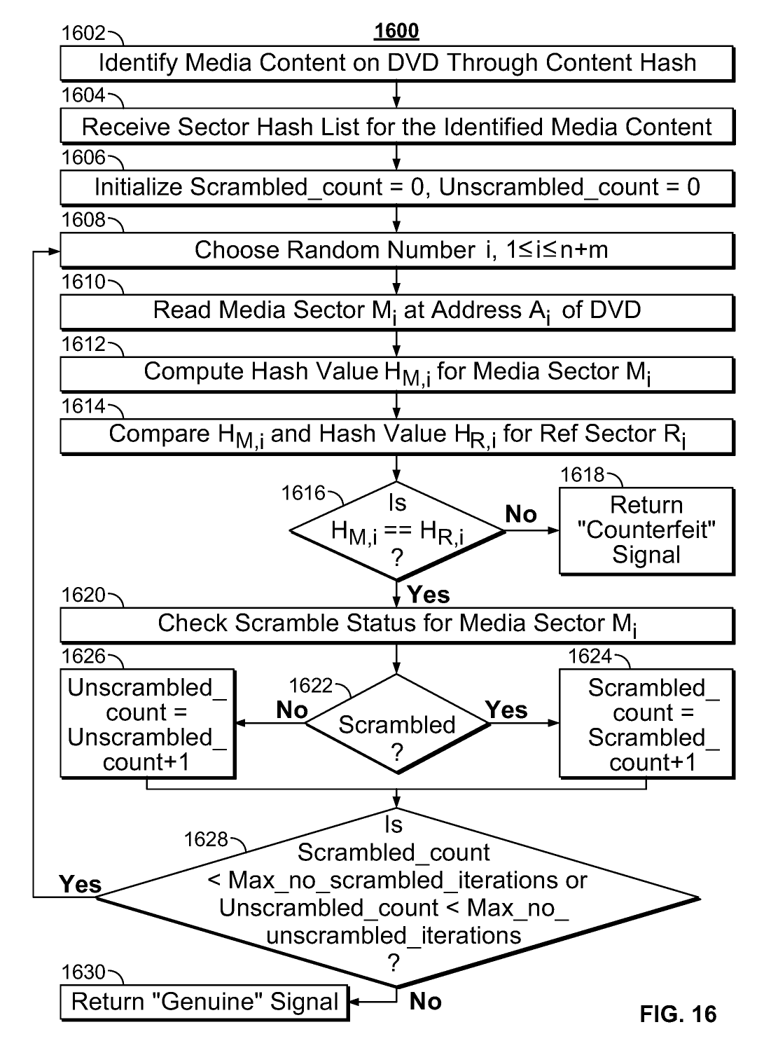

FIG. 16 shows yet another illustrative embodiment of a flow diagram 1600 for authenticating a digital file stored on a DVD implemented on processing circuitry included in, e.g., user equipment device 300 or device 604. This embodiment compares a hash value of a scrambled or an unscrambled reference sector with a hash value of a corresponding media sector stored in the digital file stored on the DVD, and also enforces that a minimum number of scrambled and unscrambled sectors be included. At step 1602, processing circuitry 306 identifies media content stored in the received digital file on the DVD. The media content is identified based on a hash of the content. For example, device 604 may apply a hash function to the files stored on a DVD of Universal Pictures' “Fast Five” and use the resulting hash value to identify the movie stored on the DVD. At step 1604, processing circuitry 306 communicates with reference block data source 424 and retrieves a sector hash list for the identified media content. The sector hash list may include the following information in the form of addresses A (where sectors are stored on the DVD), hash values H (that are calculated for sectors stored at addresses A), and scramble status flags S (that indicate whether the sectors stored at addresses A are scrambled or unscrambled):

(A₁, H_{R, 1}, S_{R, 1}) for scrambled sector K(R₁),

(A₂, H_{R, 2}, S_{R, 2}) for scrambled sector K(R₂),

(Aₙ, H_{R, n}, S_{R, n}) for scrambled sector K(Rₙ),

(Aₙ₊₁, H_{R, n+1}, S_{R, n+1}) for unscrambled sector Rₙ₊₁,

(Aₙ₊₂, H_{R, n+2}, S_{R, n+2}) for unscrambled sector Rₙ₊₂,

(Aₙ₊ₘ, H_{R, n+m}, S_{R, n+m}) for unscrambled sector Rₙ₊ₘ,

where, n is the number of scrambled sectors,

m is the number of unscrambled sectors,

H_{R, i}=H(K(Rᵢ)) is the hash function for 1≤i≤n+m, and

K(Rᵢ) is sector R₁ scrambled with key K for 1≤i≤n+m

It is noted that knowledge of key K is not required for the purposes of the systems and methods described herein. Since the hash value for a media sector or a reference sector is calculated based on the scrambled data, the sectors need not be decrypted for performing the comparison of the media sector and the reference sector.

At step 1606, processing circuitry 306 initializes variables scrambled count=0 and unscrambled count=0. The variables keep track of the number of comparison iterations that are performed for scrambled and unscrambled sectors, respectively. Processing circuitry 306 stops the process when both variables reach their maximum values, max_no_scrambled_iterations and max_no_unscrambled_iterations, which may be provided by the user, received from a remote database, preset in device 300, or through other suitable means. At step 1608, processing circuitry 306 chooses a random number i between 1 and n+m. At step 1610, processing circuitry 306 reads media sector Mᵢ from address Aᵢ corresponding to reference sector Rᵢ at address Aᵢ. At step 1612, processing circuitry 306 computes hash value H_{M, i} for scrambled (or unscrambled) media sector Mᵢ. At step 1614, processing circuitry 306 compares hash values H_{M, i} for the media sector and H_{R, n} for the reference sector. At step 1616, processing circuitry 306 determines if the hash values H_{M, i} and H_{R, i} are equal, and returns a counterfeit signal at step 1618 in case of mismatch. If the hash values H_{M, i} and H_{R, i} are equal, processing circuitry 306 proceeds to step 1620 to check the scramble status for media sector Mᵢ. At step 1622, processing circuitry 306 confirms whether media sector Mᵢ is scrambled or unscrambled, and increments variable scrambled count by 1 at step 1624 if media sector Mᵢ is scrambled or increments variable unscrambled count by 1 at step 1626 if media sector Mᵢ is unscrambled. Processing circuitry 306 then moves to step 1628 and checks whether variables scrambled_count and unscrambled_count have reached max_no_scrambled_iterations and max_no_unscrambled_iterations respectively. If additional iterations remain, processing circuitry 306 proceeds to step 1608 and repeats the comparison process, otherwise processing circuitry 306 returns a genuine signal at step 1630.

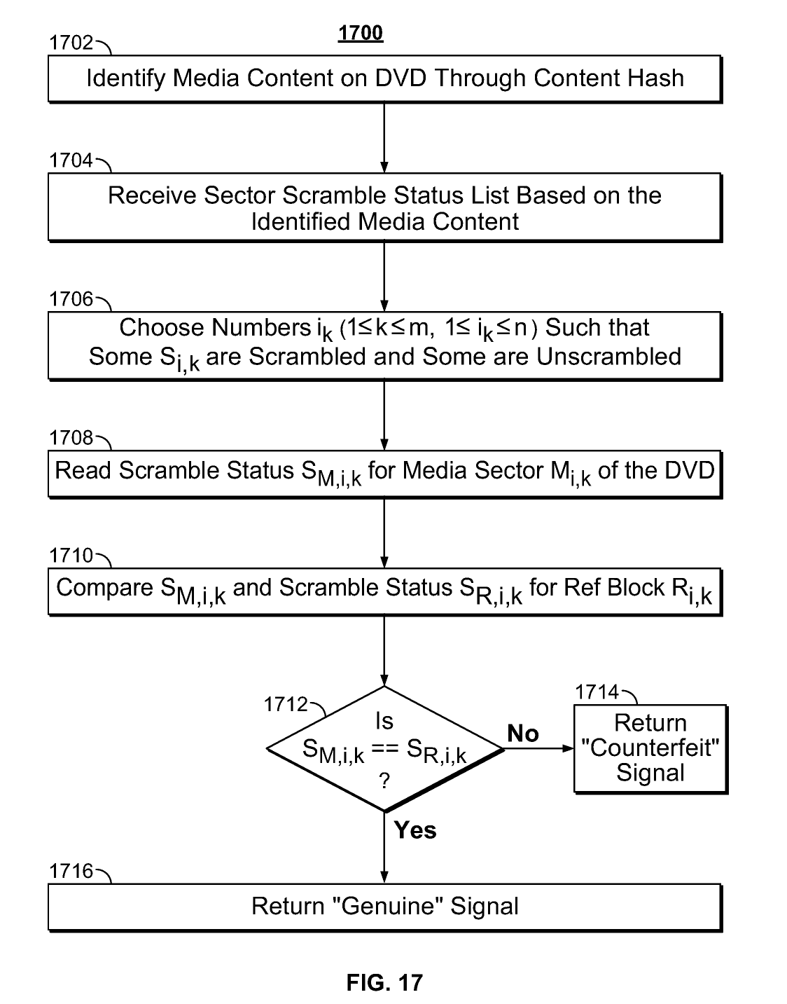

FIG. 17 shows illustrative embodiment 1700 of a flow diagram for authenticating a digital file stored on a DVD implemented on processing circuitry included in, e.g., user equipment device 300 or device 604. This embodiment compares a scramble status of a reference sector with a scramble status of a corresponding media sector stored in the digital file stored on the DVD, and also enforces that a minimum number of scrambled and unscrambled sectors be included. At step 1702, processing circuitry 306 identifies media content stored in the received digital file on the DVD. The media content is identified based on a hash of the content. For example, device 604 may apply a hash function to the files stored on a DVD of Universal Pictures' “Fast Five” and use the resulting hash value to identify the movie stored on the DVD. At step 1704, processing circuitry 306 communicates with reference block data source 424 and retrieves a sector scramble status list for the identified media content. The sector hash list may include the following information in the form of addresses A (where sectors are stored on the DVD) and scramble status flags S (that indicate whether the sectors stored at addresses A are scrambled or unscrambled):

(A₁, S_{R, 1}) for scrambled sector K(R₁),

(A₂, S_{R, 2}) for scrambled sector K(R₂),

(Aₙ, S_{R, n}) for scrambled sector K(Rₙ),

(Aₙ₊₁, S_{R, n+1}) for unscrambled sector Rₙ₊₁,

(Aₙ₊₂, S_{R, n+2}) for unscrambled sector Rₙ₊₂,

(Aₙ₊ₘ, S_{R, n+m}) for unscrambled sector Rₙ₊ₘ,

where, n is the number of scrambled sectors,

m is the number of unscrambled sectors, and

K(Rᵢ) is sector Rᵢ scrambled with key K for 1≤i≤n+m

It is noted that knowledge of key K is not required for the purposes of the systems and methods described herein. The scramble status of a media sector or a reference sector is stored in the CPR_MAI header of the sector and is typically not scrambled.

At step 1706, processing circuitry 306 chooses k instances of random number i such that k is between 1 and m and each instance of random number i is between 1 and n. Processing circuitry 306 chooses the random numbers such that some of the corresponding media sectors are scrambled and some of the corresponding media sectors are unscrambled. At step 1708, processing circuitry 306 reads scrambled status S_{M, i, k} for media sector M_{i, k} from address Aᵢ corresponding to scrambled status S_{R, i, k} for reference sector R_{i, k} at address A_{i, k} for the selected k instances of random number i. At step 1710, processing circuitry compares scramble status values of each media sector and the corresponding reference sector. At step 1712, processing circuitry 306 determines if the scramble status values are equal (or substantially equal), and returns a counterfeit signal at step 1714 in case of mismatch. For example, processing circuitry 306 may have a threshold for the number of successful comparisons that may be considered as being substantially equal. If the scramble status values are equal (or substantially equal), processing circuitry 306 returns a genuine signal at step 1716.

It will be appreciated that while the discussion of media content has focused on video content, the principles described above can be applied to other types of media content, such as music, images, etc. It will also be appreciated that while the discussion of computer readable media has focused on DVDs and related CSS copy protection systems, the principles described above can be applied to other types of computer readable media, including in combination with other types of copy protection systems.

The foregoing is merely illustrative of the principles of the systems and methods described herein, and various modifications can be made by those skilled in the art without departing from the scope and spirit of the systems and methods described herein. The above described embodiments are presented for purposes of illustration and not of limitation, and the systems and methods described herein are limited only by the claims which follow.

1-39. (canceled)

40. A method for determining whether to initiate playback, the method comprising:
receiving a request to playback media content stored in a digital file, the digital file comprising a plurality of media blocks, each media block being stored at a respective address and comprising an associated encryption flag;
in response to receiving the request to playback the media content stored in the digital file:
retrieving, from a remote database, a reference list comprising media block addresses and reference encryption flags, wherein each reference encryption flag corresponds to a media block address;
selecting a plurality of media block addresses;
accessing, in the digital file, each media block address of the plurality of media block addresses;
retrieving a corresponding encryption flag from each of the accessed media block addresses; and
determining whether each encryption flag retrieved from the corresponding media block address matches a reference encryption flag associated with the corresponding media block address; and
in response to determining that each encryption flag retrieved from the corresponding media block address matches the reference encryption flag associated with the corresponding media block address, playing back the media content.

41. The method of claim 40, wherein selecting the plurality of media block addresses comprises:
randomly selecting a subset of media block addresses in the reference list.

42. The method of claim 40, wherein selecting the plurality of media block addresses comprises:
generating a plurality of random numbers; and
selecting the plurality of media block addresses based on the generated plurality of random numbers.

43. The method of claim 40, wherein selecting the plurality of media block addresses comprises:
selecting at least one media block address of a media block that comprises an associated encryption flag that is indicative of a media block being encrypted; and
selecting at least one media block address of a media block that comprises an associated encryption flag that is indicative of a media block being unencrypted.

44. The method of claim 40, wherein each encryption flag comprises at least one of: a first value indicative of a media block being encrypted, and a second value indicative of a media block being unencrypted.

45. The method of claim 40, wherein at least one of the plurality of media blocks is encrypted using one of Content Scramble System (CSS), Advanced Access Content System (AACS), FAIRPLAY, and Protected Media Path (PMP).

46. The method of claim 40, wherein the digital file is in a format selected from the group comprising Digital Versatile Disc (DVD), Compact Disc (CD), a Blu-ray Disc (BD), a High Density DVD (HD DVD), a Hard Disk Drive (HDD), a Flash Drive, and digital content downloaded from the Internet.

47. The method of claim 40, wherein playing back the media content comprises: accessing the digital file via the internet.

48. The method of claim 40, further comprising:
in response to determining that at least one encryption flag retrieved from the corresponding media block address fails to match the reference encryption flag associated with the corresponding media block address, blocking the playback of the media content.

49. The method of claim 40, further comprising:
in response to determining that a threshold number of encryption flags retrieved from the corresponding media block address fail to match corresponding reference encryption flags associated, blocking the playback of the media content.

50. A system for determining whether to initiate playback, the system comprising:
processing circuitry configured to:
receive a request to playback media content stored in a digital file, the digital file comprising a plurality of media blocks, each media block being stored at a respective address and comprising an associated encryption flag;
in response to receiving the request to playback the media content stored in the digital file:
retrieve, from a remote database, a reference list comprising media block addresses and reference encryption flags, wherein each reference encryption flag corresponds to a media block address;
select a plurality of media block addresses;
access, in the digital file, each media block address of the plurality of media block addresses;
retrieve a corresponding encryption flag from each of the accessed media block addresses; and
determine whether each encryption flag retrieved from the corresponding media block address matches a reference encryption flag associated with the corresponding media block address; and
in response to determining that each encryption flag retrieved from the corresponding media block address matches the reference encryption flag associated with the corresponding media block address, play back the media content.

51. The system of claim 50, wherein when selecting the plurality of media block addresses, the processing circuitry is configured to:
randomly select a subset of media block addresses in the reference list.

52. The system of claim 50, wherein when selecting the plurality of media block addresses, the processing circuitry is configured to:
generate a plurality of random numbers; and
select the plurality of media block addresses based on the generated plurality of random numbers.

53. The system of claim 50, wherein when selecting the plurality of media block addresses, the processing circuitry is configured to:
select at least one media block address of a media block that comprises an associated encryption flag that is indicative of a media block being encrypted; and
select at least one media block address of a media block that comprises an associated encryption flag that is indicative of a media block being unencrypted.

54. The system of claim 50, wherein each encryption flag comprises at least one of: a first value indicative of a media block being encrypted, and a second value indicative of a media block being unencrypted.

55. The system of claim 50, wherein at least one of the plurality of media blocks is encrypted using one of Content Scramble System (CSS), Advanced Access Content System (AACS), FAIRPLAY, and Protected Media Path (PMP).

56. The system of claim 50, wherein the digital file is in a format selected from the group comprising Digital Versatile Disc (DVD), Compact Disc (CD), a Blu-ray Disc (BD), a High Density DVD (HD DVD), a Hard Disk Drive (HDD), a Flash Drive, and digital content downloaded from the Internet.

57. The system of claim 50, wherein, when playing back the media content, the processing circuitry is configured to access the digital file via the internet.

58. The system of claim 50, wherein the processing circuitry is further configured to:
in response to determining that at least one encryption flag retrieved from the corresponding media block address fails to match the reference encryption flag associated with the corresponding media block address, block the playback of the media content.

59. The system of claim 50, wherein the processing circuitry is further configured to:
in response to determining that a threshold number of encryption flags retrieved from the corresponding media block address fail to match corresponding reference encryption flags associated, block the playback of the media content.
